(19) United States
(12) Patent Application Publication
(10) Pub. No.: US 2026/0126961 A1
(43) Pub. Date: May 7, 2026

(54) METHODS AND A DEVICE FOR CONTROLLING IOT DEVICES THROUGH A DYNAMIC USER INTERFACE

(71) Applicant: Samsung Electronics Co., Ltd., Suwon-si (KR)

(72) Inventors: Karthikeyan SUBRAMANI, Bengaluru (IN); Gokul GOVINDARAJ, Bengaluru (IN); Vikalp MULLICK, Bengaluru (IN); Kaushik DAS, Bengaluru (IN)

(21) Appl. No.: 19/434,897

(22) Filed: Dec. 29, 2025

Related U.S. Application Data
(63) Continuation of application No. PCT/KR2024/006801, filed on May 20, 2024.

(30) Foreign Application Priority Data
Jul. 6, 2023 (IN) 202341045565
Apr. 19, 2024 (IN) 2023 41045565

(51) Int. Cl. G06F 8/33

(52) U.S. Cl. CPC G06F 8/33

(57) ABSTRACT

Methods to dynamically generate at least one widget/user interface (UI) with an artificial intelligence (AI) model for determining user intent/context based on user input of either voice or text, and identifying one or more associated devices with their controls/capabilities that can be provided to the user to interact with it are provided. Further, methods for correlating the user input and device information, and personalizing the AI model with user interaction, location, device information, which will be used for generating the desired at least one widget/UI are provided.

### CROSS-REFERENCE TO RELATED APPLICATION(S)

This application is a continuation application, claiming priority under 35 U.S.C. § 365 (c), of an International application No. PCT/KR2024/006801, filed on May 20, 2024, which is based on and claims the benefit of an Indian Provisional patent application number 202341045565, filed on Jul. 6, 2023, in the Indian Intellectual Property Office, and of an Indian Complete patent application number 202341045565, filed on Apr. 19, 2024, in the Indian Intellectual Property Office, the disclosure of each of which is incorporated by reference herein in its entirety.

### BACKGROUND

### 1. Field

The disclosure relates to a field of automation systems. More particularly, the disclosure relates to method(s) and a device to control a plurality of Internet of Things (IoT) device(s) via one or more auto-generated dynamic user interfaces.

### 2. Description of Related Art

In general, simultaneously controlling a plurality of IoT devices within an environment involves navigating through multiple screens and interacting with one or more nested user interfaces, leading to a lack of intuitiveness in the process. When a user wants to control a plurality of IoT devices, they have the option of either manual operation or seeking assistance from others. However, manually operating the devices may not offer the desired level of convenience and comfort to the user, often requiring additional effort. The user has an option to either adhere to predefined actions or establish their own routines for controlling the plurality of IoT devices. If the user requires changes in the device settings, the user will further have to traverse different screens, or to modify the automation with desired settings, or need to execute the automations again. However, creating routines for every user context is not always feasible and the task of remembering and maintaining all these routines becomes challenging.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and devices for control one or more functions of a plurality of internet of things (IoT) devices through a dynamic user interface (UI).

Another aspect of the disclosure is to provide methods and devices for generating a dynamic UI, wherein the dynamic UI is configured to display one or more control functions corresponding to the plurality of IoT devices for controlling the performance of the one or more IoT devices.

Another aspect of the disclosure is to provide methods and devices for automatically generating in the device, a dynamic user interface using an artificial intelligence (AI) and machine learning (ML) based module, in order to control function of the plurality of IoT devices arranged in a local IoT environment.

Another aspect of the disclosure is to provide methods and devices for controlling function(s) of the plurality of IoT devices in the local IoT environment, based on at least one user input data corresponding to at least one user query intent for a desired mental and/or physical state of the user.

Another aspect of the disclosure is to provide methods and devices for determining one or more relevant IoT devices from the plurality of IoT devices using an AI and ML based module, in order to control one or more functions thereof, wherein the one or more relevant IoT devices are determined based on a correlation between the user input data and the plurality of IoT devices.

Another aspect of the disclosure is to provide methods and devices for generating the dynamic UI, wherein the dynamic UI integrates the plurality of control functions for the plurality of IoT devices by correlating the input data and information related to the plurality of IoT devices.

Another aspect of the disclosure is to provide methods and devices for generating the dynamic user interfaces for the plurality of control functions for the plurality of IoT based devices, based on a location of the user desiring a plurality of predefined control functions for the plurality of IoT based devices.

Additional aspects will be set forth in part in the description which follows and, in part, will be apparent from the description, or may be learned by practice of the presented embodiments.

In accordance with an aspect of the disclosure, a method for regulating controlling performance of a plurality of IoT devices through a dynamic UI is provided. The method includes receiving, by an AI module, at least one user input query, wherein the at least one user input query includes at least one user intent for a localized ambience created by the plurality of IoT devices, identifying, by the AI module, one or more IoT devices from the plurality of IoT devices as contextually relevant to the user input query, determining, by the AI module, one or more control functions of the identified one or more IoT devices for achieving the localized ambience created by the plurality of IoT devices, generating, by the AI module, the dynamic UI associated with the identified one or more IoT devices, wherein the generated dynamic UI enables the at least one user input query to control the determined one or more control functions to achieve the localized ambience.

In accordance with another aspect of the disclosure, a method for generating a dynamic interface to control IoT devices arranged within a smart home is provided. The method includes receiving by an AI module, information including a desired physical and mental state of a user, identifying, by the AI module, one or more devices in the smart home and their associated operational parameters that are required to be adjusted to achieve the desired physical and mental state of the user, and generating by the AI module an integrated UI having the operational parameters of the identified one or more devices, wherein the operational parameters are user operable via the integrated UI in order to achieve a change in the physical and mental state of the user.

In accordance with yet another aspect of the disclosure, a device is provided. The interface device includes memory storing instructions for an AI module, at least one processor communicably coupled with the memory, wherein the instructions, when executed by the at least one processor individually or collectively, cause the AI module to receive at least one user input query, wherein the at least one user input query includes at least one user intent for a localized ambience created by a plurality of IoT devices, identify one or more IoT devices from the plurality of IoT devices as contextually relevant to the user input query, determine one or more control functions of the identified one or more IoT devices for achieving the localized ambience created by the plurality of IoT devices, generate the dynamic UI associated with the identified one or more IoT devices, wherein the generated dynamic UI enables the at least one user input query to control the determined one or more control functions to achieve the localized ambience.

In accordance with yet another aspect of the disclosure, a device is provided. The interface device includes memory storing instructions for an AI module, at least one processor communicably coupled with the memory, wherein the instructions, when executed by the at least one processor individually or collectively, cause the AI module to receive information including a desired physical and mental state of a user, identify one or more devices in smart home and their associated operational parameters that are required to be adjusted to achieve the desired physical and mental state of the user, and generate an integrated UI having the operational parameters of the identified one or more devices, wherein the operational parameters are user operable via the integrated UI in order to achieve a change in the physical and mental state of the user.

In accordance with still another aspect of the disclosure, one or more non-transitory computer-readable storage media storing instructions that, when executed by at least one processor of a device individually or collectively, cause the device to perform operations for an AI module, is provided. The operations include receiving at least one user input query, wherein the at least one user input query includes at least one user intent for a localized ambience created by a plurality of IoT devices, identifying one or more IoT devices from the plurality of IoT devices as contextually relevant to the user input query, determining one or more control functions of the identified one or more IoT devices for achieving the localized ambience created by the plurality of IoT devices, and generating the dynamic user interface (UI) associated with the identified one or more IoT devices, wherein the generated dynamic UI enables the at least one user input query to control the determined one or more control functions to achieve the localized ambience.

In accordance with still another aspect of the disclosure, one or more non-transitory computer-readable storage media storing instructions that, when executed by at least one processor of a device individually or collectively, cause the device to perform operations for an AI module, is provided. The operations include receiving information including a desired physical and mental state of a user, identifying one or more devices in smart home and their associated operational parameters that are required to be adjusted to achieve the desired physical and mental state of the user, and generating an integrated user interface (UI) having the operational parameters of the identified one or more devices, wherein the operational parameters are user operable via the integrated UI in order to achieve a change in the physical and mental state of the user.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 depicts the interface device for generating the dynamic user interface (UI) in the interface device (102) in order to control performance of a plurality of IoT devices arranged in a local IoT environment, according to an embodiment of the disclosure;

FIG. 2 depicts a system for controlling through a dynamic UI, a localized ambience created by a plurality of IoT devices, according to an embodiment of the disclosure;

FIG. 3 depicts a method for generating a dynamic user interface based on one or more user intents, according to an embodiment of the disclosure;

FIGS. 4A and 4B depict methods for extracting one or more user intent and one or more entity features from the user data, according to various embodiments of the disclosure;

FIG. 5 depicts an example of at least one sentiment classification model configured for obtaining one or more user intent from the one or more user data, according to an embodiment of the disclosure;

FIG. 6 depicts a method for controlling performance of a plurality of Internet of Things (IoT) devices arranged in a physical world, through a dynamic User Interface (UI) created in a metaverse world, according to an embodiment of the disclosure; and

FIGS. 7, 8, and 9 depict example use cases, according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the disclosure matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

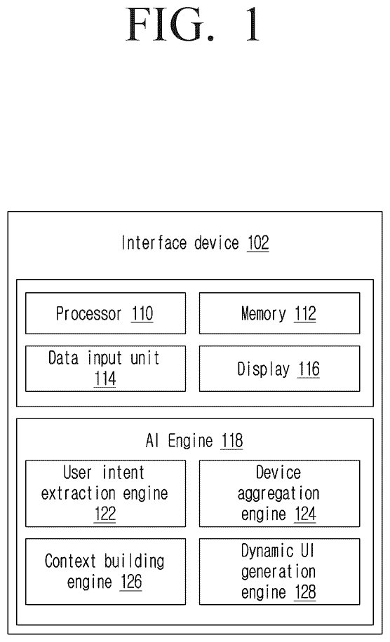

The embodiments herein achieve methods and systems for controlling an IoT device in a smart home using a dynamically generated UI/widget. Referring now to the drawings, and more particularly to FIGS. 1 to 3, 4A, 4B, and 5 to 9, where similar reference characters denote corresponding features consistently throughout the figures, there are shown at least one embodiment.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 depicts the interface device (102) for generating one or more dynamic user interfaces (UIs) in the interface device (102) in order to control performance of a plurality of IoT devices arranged in a local IoT environment according to an embodiment of the disclosure.

The interface device (102) comprises a processor (110), memory (112), a data input unit (114), a display (116), and an AI engine (118). In an embodiment herein, the AI engine (118) can include a user intent extraction engine (122), a device aggregation engine (124), a context building engine (126) and a dynamic UI generation engine (128). The interface device (110) may also comprise several other components such as a communication module (not shown) for enabling communication between internal hardware components of the interface device. The communication module (not shown) can enable communication between the interface device (102) and one or more external devices/accessories, such as, but not limited to, a plurality of IoT devices, a touch sensitive screen/pad, a capacitive button, a keyboard, a mouse, an accelerometer, an image capturing unit, a light emitting diode (LED) indicator, a speaker, a haptic feedback device, a geo-location unit and so on, thereby enabling the interface device (102) to output several data related to the one or more user intent and the plurality of control functions for the plurality of selective IoT devices and so on. Further, the interface device (102) may comprise several other engines configured with the AI engine (118) for carrying out various miscellaneous functionalities of the interface device (102). It will be appreciated that such aforementioned engines may be represented as a single engine or a combination of different engines. The AI engine (118) can be implemented in the form of software executed by a processor, hardware and/or firmware.

The processor (110) can process various computer-executable instructions to control the operation(s) of the interface device (102) and to enable techniques for controlling the plurality of IoT devices based on one or more user input data. Further, the processor (110) can execute instructions stored in the memory (112) and to perform various processes for controlling the operation(s) of the plurality of IoT devices. The processor (110) can include at least one of a single processer, a plurality of processors, multiple homogeneous or heterogeneous cores, multiple CPUs of different kinds, and a microcontroller. Further, the plurality of processing units may be located on a single chip or over multiple chips. The processor (110) can process the one or more user input data for determining one or more user intent corresponding to a plurality of operation control functions of the plurality of IoT based devices, in order to control thereof based on the one or more user intent as determined.

The memory (112) can store instructions to be executed by the processor (110). The memory (112) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. Further, in an example embodiment, the memory can store usage history of the plurality of IoT devices, wherein the usage history comprises device ON/OFF state, device OPEN/CLOSE state, and device operating control functions at various timestamps. The memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random Access Memory (RAM) or cache).

The data input unit (114) can receive one or more data (hereinafter referred to as user data) in relation to one or more user intent(s) corresponding to the plurality of IoT devices in order to control a plurality of operation control functions for the plurality of IoT devices for achieving one or more desired physical and/or mental state for the user. In an embodiment, the data input unit (114) can comprise one or more input output ports integrated with the interface device (102) for enabling the user to input the one or more data to the processor manually. Examples of the input output ports can be, but not limited to, an image capturing unit, a microphone, a keyboard, a touch screen, and so on.

The display (116) of the interface device (102) can present one or more widgets corresponding to the data input and one or more control functions related to controlling one or more operation control functions of the plurality of IoT devices to the user. In an example embodiment, the one or more operation control functions of the plurality of IoT devices are such as:
ON/OFF state; open/close state; temperature, windspeed, etc., relating to operational state of an IoT device such as an air conditioner (AC);
Volume, channel, home mode, Applications, etc., relating to operation of an IoT device such as an entertainment equipment;
Color, brightness, color temperature of an IoT device such as a bulb;
Water level, rinse level, spin level of an IoT device such as a washer equipment;
Temperature, frost level, etc., for a refrigerator; and
Wind speed, filter clean for an air purifier, and so on several control functions defining operational mode of the plurality of IoT devices.

In an embodiment, the one or more operation control functions further can include usage history of the one or more IoT devices based on one or more physical and mental state of the user.

Further, the display (116) can display, one or more confidence scores in relation to the one or more operation control functions of the plurality of IoT devices, in a tabular format, once the context building engine (126) generates output. In an embodiment herein, the display (116) can be integrated with the interface device (102), such as display of the interface device (102). In an embodiment herein, the display (116) can be a stand-alone display communicatively coupled with the interface device (102) for displaying characters, textual and graphical representation of input and output.

The AI engine (118) can generate the one or more dynamic user interfaces based on one or more user data. In an embodiment, the one or more user data comprises of one or more user input queries corresponding to a desired mental and/or physical state of the user of the interface device (102). The AI engine (118) further comprises a user intent extraction engine (122), a device aggregation engine (124), a context building engine (126), and a dynamic UI generation engine (128). In an example embodiment, the AI engine (118) can acquire the one or more user data from the data input unit (114). The user intent extraction engine (122) can extract one or more user intent from the one or more user data by analyzing emotions and/or sentiments of the user through at least a sentiment classification mechanism or any other suitable mechanism for detecting the desired mental state of the user. The device aggregation engine (124) can generate an aggregated output comprising a plurality of unique identification number corresponding to the plurality of IoT devices, and a plurality of respective control functions corresponding to the plurality of IoT devices performing at various timestamps.

Output from the user intent extraction engine (122) and the device aggregation engine (124) can be provided to the context building engine (126). The context building engine (126) can generate a plurality of agglomerative contextual features from the one or more user intents and the plurality of control functions of the plurality of IoT devices in the local IoT environment. In an embodiment herein, the agglomerative contextual features comprise one or more operation control functions of one or more IoT devices selected from the plurality of IoT devices based on location of the selected one or more IoT devices within the local IoT environment. Further, the context building engine (126) can perform a correlation operation between the one or more user intents and the agglomerative contextual features. Furthermore, the context building engine (126) can perform correlation to generate one or more confidence scores, corresponding to the selected plurality of IoT devices.

Output from the context building engine (126) can be provided to the dynamic UI generation engine (128). The dynamic UI generation engine (128) can generate a dynamic user interface comprising one or more widgets. The one or more widgets comprise the one or more control functions for the one or more IoT devices as selected from the plurality of IoT devices. The one or more control functions for the one or more IoT devices are generated for controlling the one or more operation control functions of the as selected one or more IoT devices. In an example embodiment, the dynamic UI generation engine (128) can include a foundation model trained with a plurality of graphical images corresponding to the plurality of operation control functions of the plurality of IoT devices, in order to generate one or more relevant graphical images in the one or more widgets as rendered in the dynamic user interface (UI). Further, the dynamic UI generation engine (128) can be trained with one or more data, that includes the one or more user intents, the plurality of IoT devices (202) and their location information within a local IoT environment, the one or more relevant confidence scores as determined corresponding to the control functions of the one or more IoT devices as identified as contextually relevant, a history of interactions of the interface device (102) at several timestamps with the plurality of IoT devices (202) arranged in the local IoT environment, and one or more events corresponding to device usage history with the plurality of IoT devices (202) having the one or more operation control functions corresponding to each IoT device.

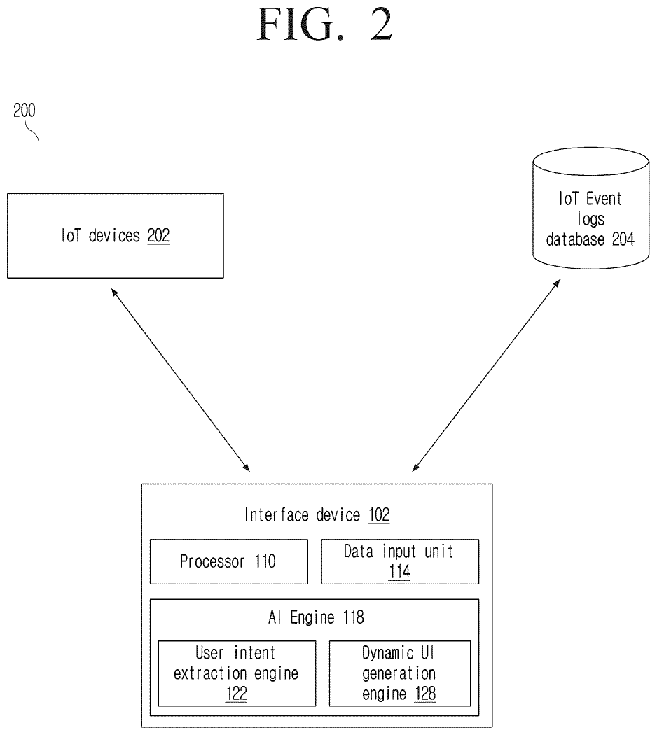

FIG. 2 depicts a system (200) for controlling through a dynamic UI, a localized ambience created by a plurality of IoT devices according to an embodiment of the disclosure.

The system comprises an interface device (102), a plurality of IoT devices (202), and at least one event log database (204). The interface device further comprises, a data input unit (114), an AI engine (118) and a communication module (not shown). The interface device (102) is facilitating communication with the plurality of IoT devices (202), and the at least one event log database (204), via the communication module. The data input unit (114) can receive one or more user data from at least one user, wherein the user data includes user intent of the user. The user intent can be extracted by the AI engine (118) in order to identify one or more IoT devices from the plurality of IoT devices, as relevant to the user intent. The AI engine (118) can receive from the IoT events logs database (204), a unique identity of a plurality of IoT devices with unique identification numbers, a plurality of operation control functions (such as an example, ON/OFF state of AC, etc.) corresponding to the plurality of IoT devices and information related to the device usage history at various timestamps. Further, the AI engine (118) can generate an aggregated output comprising one or more IoT devices having the unique identity and the respective one or more operation control functions. Further, the AI engine (118) can select one or more IoT devices from the aggregated output as one or more relevant IoT devices, satisfying user intent. The one or more relevant IoT devices can be selected by a correlation analysis, which generates a confidence score corresponding to the one or more relevant IoT devices. Furthermore, a dynamic UI can be generated by the AI engine (118), wherein the dynamic UI comprises one or more widgets including one or more relevant operation control functions corresponding to the one or more relevant IoT devices. In an embodiment, the AI engine (118) can include a foundation model, trained with a plurality of graphical images corresponding to a plurality of operation control functions of the plurality of IoT devices (202), in order to generate one or more relevant graphical images in the one or more widgets as rendered in the dynamic user interface (UI). Further, the AI engine (118) can be trained with one or more data for generating the dynamic UI. In an embodiment herein, the one or more data includes the one or more user intent, the plurality of IoT devices (202) and their location information within a local IoT environment, the one or more relevant confidence scores as determined corresponding to the control functions of the one or more IoT devices as identified as contextually relevant, a history of interaction of the interface device (102) at several timestamps with the plurality of IoT devices (202) arranged in the local IoT environment, and one or more events corresponding to device usage history with the plurality of IoT devices (202) having the one or more operation control functions corresponding to each IoT device. The at least one user of the interface device (102) can select one or more IoT device from the dynamic UI as rendered and control operation control functions for the one or more IoT device.

The interface device (102) includes a processor (110) (e.g., any of microprocessors, controllers, or other controllers). The system (200) can be implemented with any one or combination of hardware elements firmware, or fixed logic circuitry that is implemented in connection with processing and control circuits. Although not shown, the system (200) can include a system bus or data transfer system that couples the various components within the interface device (102). A system bus can include any one or combination of different bus structures, such as a memory bus or memory controller, a peripheral bus, a universal serial bus, and/or a processor or local bus that utilizes any of a variety of bus architectures.

The system (200) also includes a communication module (not shown) that enables wired and/or wireless communication of data (e.g., external data). The communication module can be implemented as one or more of a serial and/or parallel interface, a wireless interface, any type of network interface, a modem, or as any other type of communication interface. The communication module provides a connection and/or communication links between the interface device (102), the plurality of IoT devices (202) and the events log database (204) for facilitating communication of data.

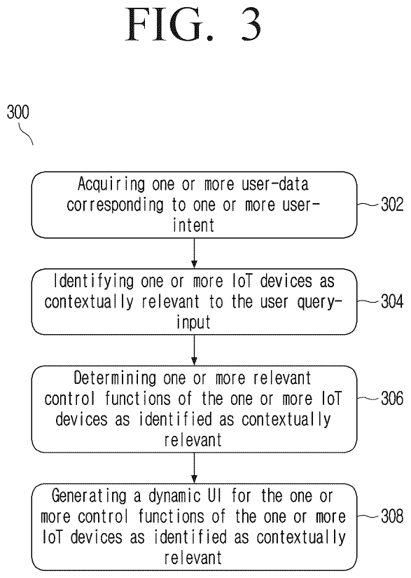

FIG. 3 depicts a method (300) for generating a dynamic user interface based on one or more user intents according to an embodiment of the disclosure.

At operation 302, the method (300) comprises acquiring by a user intent extraction engine (122) (as configured within an AI engine (118)) one or more user data comprising one or more user input queries corresponding to one or more user intents. The one or more user intent can be one or more desired mental and/or physical state of the user. In an embodiment herein, the user intent extraction engine (122) can extract one or more user intent from the one or more user data using at least a sentiment classification module. The sentiment classification module can be an AI and ML based classification module. In an embodiment herein, the user intent extraction engine (122) can receive the one or more user data from a data input unit present in the interface device (102) via a communication module, wherein the communication module facilitates communication between the data input unit and the user intent extraction engine (122) (as configured within the AI engine (118)).

At operation 304, the method (300) includes identifying by a context building engine (126) (as configured within the AI engine (118)) one or more IoT devices from a plurality of IoT devices (202) contextually relevant to the user input query, wherein the plurality of IoT devices are arranged within a local IoT environment. In an embodiment, method of identifying the one or more IoT devices as contextually relevant, further comprises a step of generating by a device aggregation engine (124) an agglomerative contextual device features comprising a plurality of unique identifiers with location information within the local IoT environment, corresponding to the plurality of IoT devices (202), name of the plurality of IoT devices and a plurality of events occurrence with respect to the plurality of IoT devices at various timestamps and so on. In an embodiment, the plurality of events can be such as the usage history of the plurality of IoT devices including ON/OFF status, OPEN/CLOSE status and operation control functions corresponding to the plurality of IoT devices. In an example embodiment, the device aggregation engine (124) can extract data related to the unique identifiers with location information of the plurality of IoT devices (202) arranged within the local IoT environment and name of the plurality of IoT devices from the memory (112). Further, the device aggregation engine (124) of the interface device (102) can extract information related to the device usage history from an IoT event log database, wherein the interface device (102) facilitates communication with the IoT event log database (204) via the communication module. The method of identifying the one or more IoT devices as contextually relevant further comprises determining one or more confidence scores using correlation analysis between the one or more events of the plurality of IoT devices (202) including usage history for each IoT device of the plurality of IoT devices (202) and the one or more user input queries. Therefore, the one or more IoT devices are prioritized from the plurality of IoT devices (202) based on the one or more confidence score corresponding to the one or more IoT devices in order to be identified as contextually relevant.

At operation 306, the method (300) comprises determining by the context building engine (126), one or more relevant operation control functions for the one or more IoT devices as identified as contextually relevant to the one or more user intent, wherein the one or more relevant operation control functions are determined from the confidence score corresponding to the one or more operation control functions as obtained for the correlation analysis as described in operation 304, wherein the one or more operation control functions are determined as essential operation control functions for achieving the one or more user intent as detected based on the one or more user input query.

At operation 308, the method (300) comprises generating by a dynamic UI generation engine (128) (as configured within the AI engine (118)), a dynamic user interface (UI) comprising one or more widgets, wherein the one or more widgets further comprise the one or more control functions corresponding to the one or more IoT devices as determined as contextually relevant to the one or more user intent. In an example embodiment, the dynamic UI generation engine (128) can include a foundation model trained with a plurality of graphical images corresponding to the plurality of control functions of the plurality of IoT devices, to generate relevant one or more graphical images in the one or more widgets. The one or more graphical images correspond to the one or more control functions for the one or more IoT devices, as rendered in the dynamic user interface (UI). Further, with respect to various embodiments as disclosed herein, the dynamic UI generation engine (128) can be further trained with one or more data for generating the dynamic user interface. In an embodiment herein, the one or more data includes the one or more user intent, the plurality of IoT devices and their location information within the local IoT environment, the one or more relevant confidence scores as determined corresponding to the control functions of the one or more IoT devices as identified as contextually relevant, a history of interaction of one or more interface device with the plurality of IoT devices (202) arranged in the local IoT environment, at several timestamps, and the one or more events corresponding to device usage history with the one or more operation control functions of the plurality of IoT devices. The various actions in method 300 may be performed in the order presented, in a different order or simultaneously. Further, in some embodiments, some actions listed in FIG. 3 may be omitted.

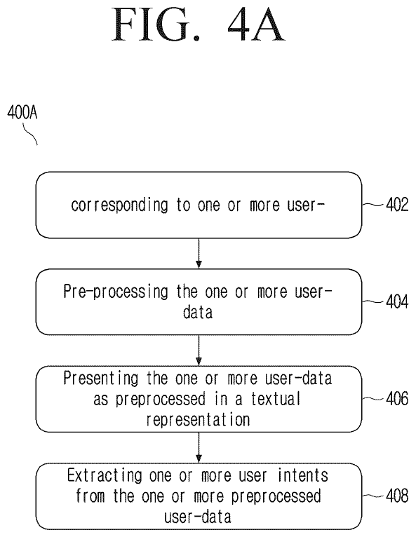

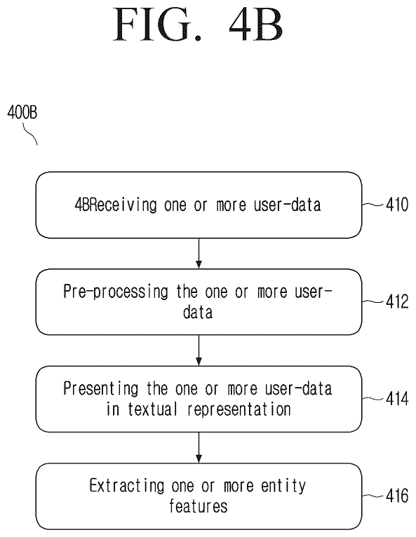

FIGS. 4A and 4B depict a method (400A) and a method (400B) for extracting one or more user intent and one or more entity features from the one or more user data as received by the data input unit (114) of the interface device (102) according to various embodiments of the disclosure.

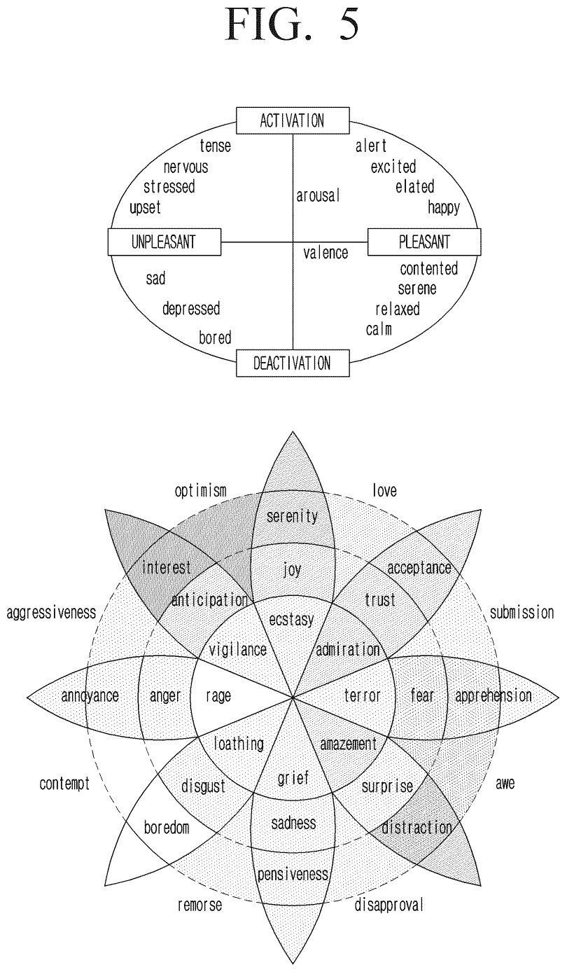

Referring to FIG. 4A, the method (400A) for extracting one or more user intent from the one or more user data includes, at operation 402, obtaining by the user intent extraction engine (122) (as configured with the AI engine (118)) one or more user data, wherein the user intent extraction engine (122) is communicably coupled with the data input unit (114) and configured to obtain the one or more user data from the data input unit. In an embodiment, the one or more user data can be such as, without limitation, one or more audio data, one or more text data, and one or more image data. Further, the method (400A) for extracting one or more user intent from the one or more user data includes at operation 404, pre-processing of the one or more user data by the user intent extraction engine of the AI module, wherein the pre-processing can include stemming, tokenizing and lemmatizing of the one or more user data by way of natural language processing technique. Pre-processing of the user data can be carried out in order to obtain one or more filtered user data containing one or more root words of the user data as obtained. The method (400A) for extracting one or more user intent from the one or more user data includes at operation 406, presenting by the one or more user data as pre-processed in a textual representation comprising one or more text based features of the user data as pre-processed. The one or more text based features can comprise one or more sentiments (herein referred as user intent) of the user associated with the one or more user data as received and/or one or more entity features associated with the one or more user data as received. Further, the method (400A) for extracting one or more user intents from the one or more user data includes at operation 408, extracting by the user intent extraction engine, the one or more user intent by analyzing patterns thereof from the user data as pre-processed. Extracting the one or more user intent can be carried out by using a statistical model based approach including a sentiment classification model (FIG. 5) of the user intent extraction engine.

Referring to FIG. 4B, the method (400B) for extracting one or more entity features from the one or more user data includes, at operation 410, obtaining by the user intent extraction engine (122) configured with the AI engine (118) one or more user data. In an embodiment, the one or more user data can be such as without limitation one or more audio data, one or more text data and one or more image data. Further, the method (400B) for extracting one or more entity features from the one or more user data includes at operation 412, pre-processing of the one or more user data by the user intent extraction engine of the AI module. Pre-processing of the one or more user data can include stemming, tokenizing and lemmatizing of the one or more user data by way of natural language processing techniques, to obtain one or more filtered user data containing one or more root words of the user data.

The method (400B) for extracting one or more entity features from the one or more user data includes at operation 414, presenting by the pre-processed user data in a textual representation, wherein the representation comprises one or more text based features of the pre-processed user data. The one or more text based features can comprise one or more sentiments (herein referred as user intent) of the user associated with the one or more user data as received and/or one or more entity features associated with the one or more user data as received.

Further, the method (400B) for extracting one or more entity features from the one or more user data includes at operation 416, extracting by the user intent extraction engine the one or more entity features by analyzing patterns from the pre-processed user data. Extracting the one or more entity features can be carried out by using a model based approach including such as a conditional random field model. The one or more entity features can comprise such as one or more location features associated with the one or more user data, one or more identifier numbers of the one or more IoT devices and so on.

FIG. 5 depicts an example of at least one sentiment classification model configured for obtaining one or more user intent from the one or more user data according to an embodiment of the disclosure.

The sentiment classification model can be a statistical based model involving machine learning algorithms for extracting one or more user intent from one or more user data. Further, the sentiment classification module can be represented in at least one of a two dimensional (2D) model or a three dimensional (3D) wheel model of emotions. The 3D wheel model can be a map to analyze the one or more user intents associated with every emotion of the user associated with the one or more user data. The model explains that, one or more basic user intents of one or more user can be different and can diverge to various forms of high level emotions, wherein the one or more basic user intents are a pair of basic emotions. The high level emotions can be obtained by integrating two emotions obtained from two basic emotions. The sentiment classification module further, can pre-process the one or more user data by way of natural language processing of the user data using stemming, tokenizing and lemmatizing mechanism in order to obtain one or more text features in a vectorial representation from the user input query. Further, the sentiment classification module can include a naive bias classification model, and/or a TF DIF classification model for detection of the one or more user intents. In an embodiment herein, the sentiment classification module can be a trained emotion classification model including a plurality of training samples of labelled and unlabelled data with pseudo labels. Further, the sentiment classification model can be a deep learning based model configured for accomplishing several natural language processing tasks to detect the one or more user intent, wherein the deep learning based model can be, but not limited to, a recurrent neural network (RNN) model, a convolutional neural network (CNN) model, a deep neural network (DNN) model, a restricted Boltzmann Machine (RBM) model, a deep belief network (DBN) model, a bidirectional recurrent deep neural network (BRDNN) model, a generative adversarial networks (GAN) model, a deep Q-networks model and so on. In an embodiment herein, the sentiment classification model can include a multimodal sentiment classifier for generating entity-level sentiment classifications for multimodal user data, the multimodal user data comprises a text data, an audio based, a video based and an image data. In some example embodiments, the multimodal sentiment classifier implements multiple recurrent neural networks (e.g., long short term memory (LSTM) neural networks), feed forward neural networks to yield pre-processing of the data for vectorial representation of the one or more user data thereby processing thereof by the multimodal sentiment classifier by way of layered operation through calculation of a previous layer and an operation of a plurality of weights.

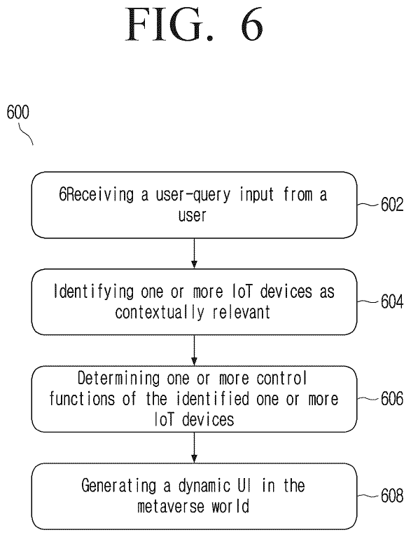

FIG. 6 depicts a method (600) for controlling performance of a plurality of Internet of Things (IoT) devices arranged in a physical world, through a dynamic User Interface (UI) created in a metaverse world according to an embodiment of the disclosure.

At operation 602, the method (600) comprises, receiving, by an AI engine (118) of the interface device (102), at least one user input query. The at least one user input query comprises at least one user intent for a localized ambience created by the plurality of IoT devices (202) within a local IoT environment in the physical world.

At operation 604, the method (600) comprises, identifying, by the AI engine (118), one or more IoT devices from the plurality of IoT devices (202) as contextually relevant to the user input query.

At operation 606, the method (600) comprises, determining, by the AI engine (118), one or more control functions of the identified one or more IoT devices from the plurality of IoT devices (202), based on the user input query.

At operation 608, the method (600) comprises, generating, by the AI engine (118), the dynamic UI in the metaverse world for the identified one or more identified IoT devices, wherein the generated dynamic UI enables the at least one user in the metaverse world to control the one or more control functions as determined to achieve a localized ambience, based on the user intent.

Embodiments herein are further exemplified by the following examples. However, the following examples illustrating application area(s) of embodiments disclosed herein and are not limiting, and embodiments as disclosed herein can be implemented in diverse fields of application.

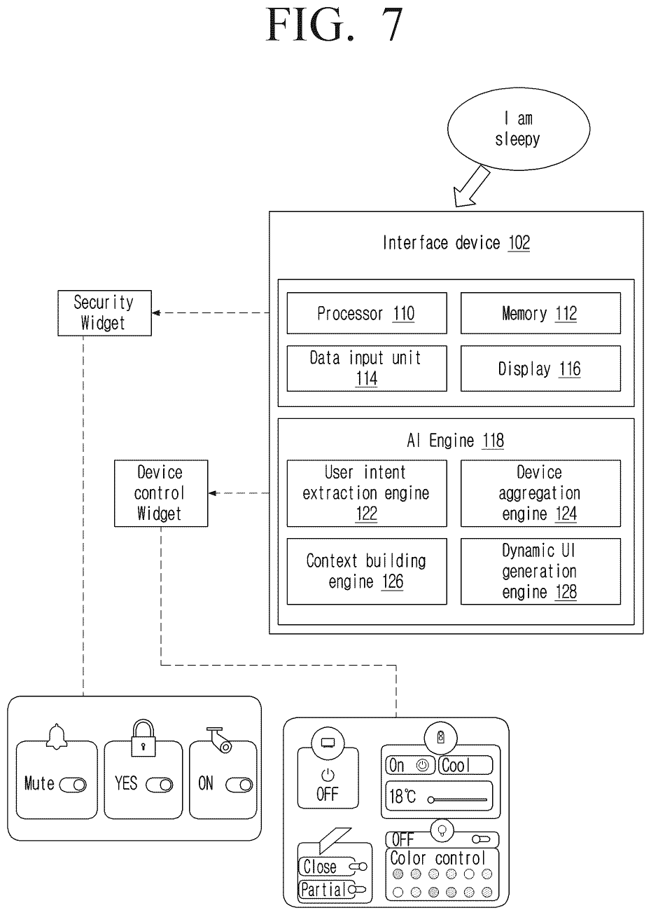

FIGS. 7, 8, and 9 depict example use cases, according to various embodiments of the disclosure.

### Example 1: a User of the Interface Device is Feeling Sleepy

Referring to FIG. 7, at least one widget/UI is generated in the interface device (102) for a user for controlling one or more IoT devices, on determining that the user is sleepy. The user wants to change the environment, so that the user can sleep comfortably. The data input unit (114) receives the user intent as user data, wherein the user data can be can be such as without limitation one or more audio data, one or more text data and one or more image data. The data input unit (114) transfers the user data to a user intent extraction engine (122) configured with an AI engine (118) of the interface device (102), via the communication module. The user intent extraction engine (122) performs extraction of user intent from the user data as received from the data input unit (114), using at least a sentiment classification mechanism. The user intent as extracted is communicated to a context building engine (126). A device aggregation engine (124) aggregates a plurality of IoT devices having a respective plurality of unique identification (UI) numbers, and a plurality of respective operation control functions corresponding to the plurality of IoT devices performing at various timestamps. Aggregation of the plurality of IoT devices with respective UI numbers and the respective operating control functions is carried out based on identifying by the user intent extraction engine (122) location of a user in the room and one or more IoT devices present in the local IoT environment (such as in the user's home). In an embodiment herein, the device aggregation engine (124) extracts from an IoT event log database (204), the plurality of unique identification numbers corresponding to the plurality of IoT devices and the plurality of respective operation control functions corresponding to the plurality of IoT devices performing at various timestamps. An aggregated output from the device aggregation engine (124) is provided to a context building engine (126). The aggregated output comprises the plurality of IoT devices with corresponding plurality of unique identification numbers and the plurality of control functions corresponding to the plurality of IoT devices. Table 1 represents an example aggregated output from the device aggregation engine (124).

TABLE 1

| Device ID | Device | Operation control functions |
|---|---|---|
| D1 | AC | Temperature, mode, |
| | | power, windspeed, blooming |
| D2 | TV | Power, Home, volume, |
| | | channel, Mute, Apps, |
| | | next, back |
| D3 | Smart blinds | Open, Close, Half |
| | | open, Partial Open |
| D4 | Light | Power, color, dim, |
| | | brightness, color temp |
| D5 | Door lock | Lock, Unlock, change |
| | | code, share code |
| D6 | Door bell | Mute, change tune |
| D7 | Camera | Resolution, zoom, record |
| D8 | RVC | Power, mode, clean, recharge |

The context building engine (126) generates a plurality of agglomerative contextual features from, the user intent as extracted from the user intent extraction engine (122) and the aggregated output from the device aggregation engine (124), by performing a correlation analysis between the user intent and the plurality of IoT devices. In an embodiment herein, the agglomerative contextual features comprise one or more operation control functions with a confidence score of one or more IoT devices selected as contextually relevant, from the aggregated output. Table 2 represents an example output from the context building engine (126).

TABLE 2

| | | Operation control functions |
|---|---|---|
| Device ID | Device | with confidence score |
| D1 | AC | Temperature (0.9), mode |
| | | (0.8), power (0.9), |
| | | windspeed (0.4) |
| D2 | TV | Power (0.95) |
| D3 | Smart blinds | Open (0.4), Close (0.9), |
| | | Partial Open (0.9) |
| D4 | Light | Power (0.9), color |
| | | (0.8), dim (0.4) |
| D5 | Door lock | Lock (0.9), change code |
| | | (0.8), share code (0.4) |
| D6 | Door bell | Mute (0.95), change |
| | | tune (0.8) |
| D7 | Camera | Resolution (0.95), zoom (0.8) |

The output from the context building engine (126) can be provided to a dynamic UI generation engine (128). The dynamic UI generation engine (128) includes a foundation model trained with a plurality of graphical images corresponding to the plurality of control functions of the plurality of IoT devices, in order to generate relevant one or more graphical images in the one or more widgets. The one or more relevant graphical images correspond to the one or more control functions for the one or more IoT devices selected as contextually relevant. Further, the dynamic UI generation engine (128) is trained with one or more data for generating the dynamic user interface. The one or more data includes the user intent, the one or more IoT devices that have been identified as contextually relevant, the one or more control functions with the one or more confidence scores corresponding to the one or more IoT devices, a history of interaction of the interface device (102) with the plurality of IoT devices (202) arranged in the local IoT environment at several timestamps, and the usage history of the interface device with the plurality of IoT devices having a plurality of operation control functions. At least one dynamic UI is generated comprising one or more widgets, wherein the one or more widgets include one or more control functions for the one or more IoT devices selected as contextually relevant. The generated widget(s) in the depicted example can ensure home security (security widget) and the user sleep peacefully (device control widget).

### Example 2: The User is Feeling Uncomfortable

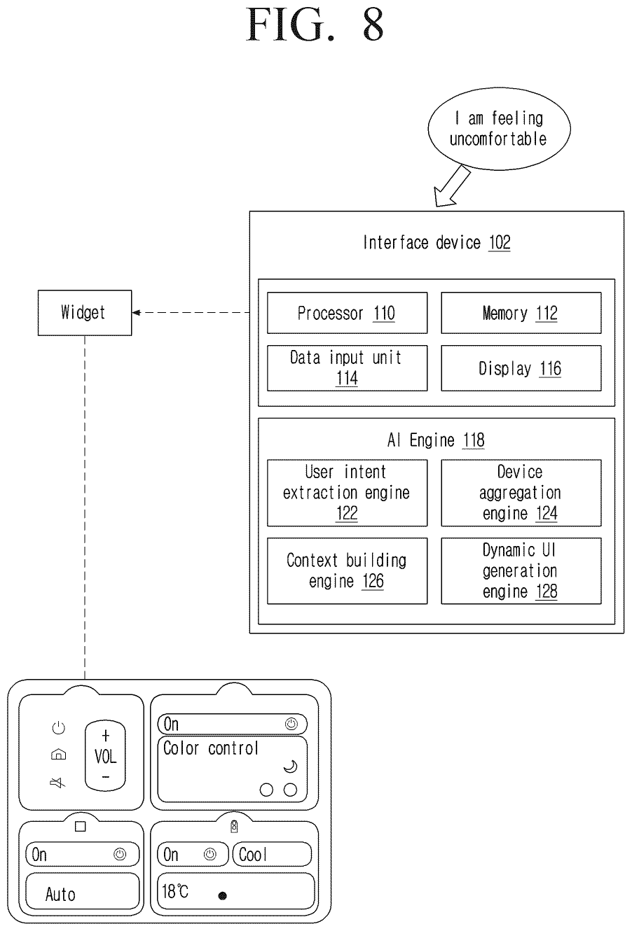

Referring to FIG. 8, at least one widget/UI is generated in the interface device (102) for a user for controlling one or more IoT devices, on determining that the user is feeling uncomfortable. Consider that the user wants to change the environment according to user intent, so that the user can feel comfortable. The data input unit (114) receives the user intent as user data. The data input unit (114) transfers the user data to the user intent extraction engine (122) configured with the AI engine (118) of the interface device (102), via the communication module. The user intent extraction engine (122) extracts user intent from the user data as received from the data input unit (114), using the sentiment classification mechanism. The user intent as extracted is communicated to the context building engine (126). The device aggregation engine (124) aggregates a plurality of IoT devices having a plurality of unique identification (UI) numbers, and a plurality of respective operation control functions corresponding to the plurality of IoT devices performing at various timestamps. Aggregation of the plurality of IoT devices with respective UI numbers and the respective operating control functions can be carried out based on identifying the location of a user in the room and one or more IoT devices present in the local IoT environment (such as in their home). In an embodiment herein, the device aggregation engine (124) extracts the plurality of unique identification numbers corresponding to the plurality of IoT devices and the plurality of respective operation control functions corresponding to the plurality of IoT devices performing at various timestamps from the IoT event log database (204). An aggregated output from the device aggregation engine (124) is provided to the context building engine (126), wherein the aggregated output comprising the plurality of IoT devices with the corresponding plurality of unique identification numbers and the plurality of control functions corresponding to the plurality of IoT devices. Table 3 represents an example aggregated output from the device aggregation engine (124).

TABLE 3

| Device ID | Device | Operation control functions |
|---|---|---|
| D1 | AC | Temperature, mode, power, |
| | | windspeed, blooming |
| D2 | TV | Power, Home, volume, channel, |
| | | Mute, Apps, next, back |
| D9 | Air purifier | Power, mode, wind |
| | | speed, filter, clean |
| D4 | Light | Power, color, dim, |
| | | brightness, color temp |
| D10 | Washer | Power, cycle, wind level, |
| | | speed level, water level |
| D11 | Refrigerator | Temperature, frost level |

The context building engine (126) generates a plurality of agglomerative contextual features from, the user intent as extracted from the user intent extraction engine (122) and the aggregated output from the device aggregation engine (124), by performing a correlation analysis between the user intent and the plurality of IoT devices. In an embodiment herein, the agglomerative contextual features comprise one or more operation control functions with a confidence score of the one or more selected IoT devices. Table 4 represents an example output from the context building engine (126).

TABLE 4

| Device ID | Device | Operation control functions |
|---|---|---|
| D1 | AC | Temperature (0.9), mode (0.8), |
| | | power (0.95), windspeed (0.4) |
| D2 | TV | Power (0.95), Home (0.7), |
| | | volume (0.85), Mute (0.95), |
| | | Apps (0.4), next |
| | | (0.4), back (0.4) |
| D9 | Air purifier | Power (0.9), mode (0.4), |
| | | wind speed (0.8) |
| D4 | Light | Power (0.95), color |
| | | (0.8), dim (0.4) |

Output from the context building engine (126) is provided to the dynamic UI generation engine (128). The dynamic UI generation engine (128) includes a foundation model trained with a plurality of graphical images corresponding to the plurality of control functions of the plurality of IoT devices, in order to generate relevant one or more graphical images in the one or more widgets. The one or more relevant graphical images correspond to the one or more control functions for the one or more IoT devices selected as contextually relevant. Further, the dynamic UI generation engine (128) can be trained with data for generating the dynamic user interface. At least one dynamic UI can be generated comprising at least one widget, wherein the at least one widget includes one or more control functions for the one or more IoT devices selected as contextually relevant. In the depicted example, the one or more widgets generated can be used to control performance of the one or more IoT devices selected as contextually relevant in order to ensure the user feels comfortable.

### Example 3: Kids Going to Study and the Mother Ensures that a Localized Environment is Ready for Studying

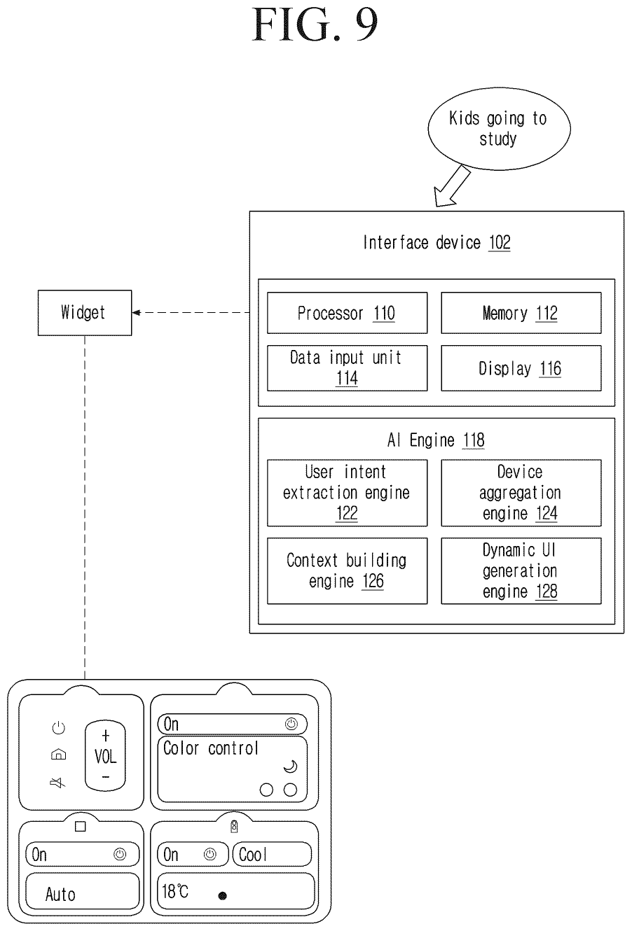

Referring to FIG. 9, a mother provides data to the data input unit (114) of the interface device (102). The user intent extraction engine (122) configured with the AI engine (118), obtains the data, and extracts the user intent. The device aggregation engine (124) aggregates a plurality of IoT devices having unique identifier numbers and a plurality of control functions, wherein the plurality of IoT devices are aggregated upon determining from the user intent, and location of kids (study room). The context building engine (126) determines one or more IoT devices as contextually relevant, from the plurality of IoT devices, based on the confidence score of the plurality of control functions corresponding to the plurality of IoT devices, obtained from a correlation analysis. The dynamic UI generation engine (128) generates at least one dynamic UI with one or more widgets including one or more relevant control functions for the one or more IoT devices as determined as contextually relevant. The one or more widgets include the one or more relevant control functions for controlling performance of AC, Air purifier, Light, TV, etc.

Embodiments herein disclose a method for dynamically generating at least one widget/UI to control IoT devices in a smart home. The method comprises receiving an input (e.g. text/audio) from a user indicating a desired user experience at a location within the smart home; and identifying one or more IoT devices and associated control functions of the IoT devices in relation to the user input. The method further comprises determining using an AI model, one or more control functions of the identified IoT devices essential to meet the desired user experience; and automatically generating a single widget/UI interface including the determined control functions wherein the widget/UI allows the user to control the IoT devices to meet the desired user experience.

The method includes receiving user input from a user for dynamically generating at least one widget/UI for controlling at least one IoT device as desired by the user at a location within the smart home. Embodiments herein can identify the user intent based on the user environment for any and every form of device and analyze the device capabilities and their correlation. Embodiments herein can analyze the user actions and personalize the device controls based on the user intent. Embodiments herein can dynamically generate the at least one widget/UI and present it to the user. Embodiments herein can use a feedback mechanism to fine tune the generation of dynamic UI Controls.

Embodiments herein disclose an AI engine (118), that will prioritize the IoT devices based on the confidence score and correlation between device and user's input. The AI model can be trained with all relevant data including user location, controls, interaction with the devices, time and other parameters and populate the controls related to the IoT devices based on the user intent/context.

Embodiments herein disclose an events log database (204) configured to store a plurality of events corresponding to device usage history with the plurality of IoT devices (202) having the one or more operation control functions corresponding to each IoT device. Table 5 depicts an example device log.

TABLE 5

| | From | To | | |
|---|---|---|---|---|
| Device | Time | Time | Activity | Other |
| Television | 20:00 | 21:30 | Turn off | Volume 55 |
| Air Purifier | 20:00 | 21:30 | Turn on | |
| Smart Bulb | 20:00 | 21:30 | Turn on | |
| AC | 20:00 | 21:30 | Turn on | |
| Fridge | 10:30 | 10:31 | Removed | |
| | | | Mushroom | |
| Micro Oven | 10:33 | 10:35 | Grill at 230 | |
| | | | degrees | |
| Geyser | 11:00 | 11:02 | 230 degree | |
| Fridge | xx | xx | xx | xx |
| xx | xx | xx | xx | xx |

Based on location of a user in a local IoT environment, and time, the one or more events are filtered. One or more event tuples are converted to vectors (device event vectors). All the device capabilities vectors are formed.

Device events vectors can be passed to a context building engine (126). The context building engine (126) scores each device events vector based on user intent, relevant devices, and user preferences, wherein more importance is given to events in which the user is more interested about routine events (giving less importance to regular events; for example, geyser ON), filter out important device vectors (importance coefficient, device relevant and understanding the situation for the user intent), consequently one or more important devices are filtered. Table 6 depicts example prioritized event logs.

TABLE 6

| | From | To | | | |
|---|---|---|---|---|---|
| Device | Time | Time | Activity | Other | Score |
| Television | 20:00 | 21:30 | Turn off | Volume 55 | 90 |
| Air Purifier | 20:00 | 21:30 | Turn on | | 88 |
| Smart Bulb | 20:00 | 21:30 | Turn on | | 87 |
| AC | 20:00 | 21:30 | Turn on | | 85 |
| Fridge | 10:30 | 10:31 | Removed | | 0.5 |
| | | | Mushroom | | |
| Micro Oven | 10:33 | 10:35 | Grill at 230 | | 0.5 |
| | | | degrees | | |
| Geyser | 11:00 | 11:02 | 230 degree | | 0.02 |
| Fridge | xx | xx | xx | xx | 0.01 |
| xx | xx | xx | xx | xx | |

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

The embodiment disclosed herein describes methods and an interface device for controlling performance of a plurality of IoT devices through a dynamic user interface. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for controlling performance of a plurality of internet of things (IoT) devices through a dynamic user interface (UI), the method comprising:
receiving, by an artificial intelligence (AI) module, at least one user input query, wherein the at least one user input query includes at least one user intent for a localized ambience created by the plurality of IoT devices;
identifying, by the AI module, one or more IoT devices from the plurality of IoT devices as contextually relevant to the user input query;
determining, by the AI module, one or more control functions of the identified one or more IoT devices for achieving the localized ambience created by the plurality of IoT devices; and
generating, by the AI module, the dynamic UI associated with the identified one or more IoT devices, wherein the generated dynamic UI enables the at least one user input query to control the determined one or more control functions to achieve the localized ambience.

2. The method as claimed in claim 1, further comprising:
retrieving, by the AI module, the at least one user intent from the at least one user input query using at least a sentiment classification mechanism for identifying the user intent.

3. The method as claimed in claim 1, further comprising:
extracting, by the AI module, from an IoT-device-history database, a list of a plurality of IoT devices and their location information within an IoT environment.

4. The method as claimed in claim 1, wherein the identifying of the one or more IoT devices from the plurality of IoT devices as contextually relevant to the user input query comprises:
extracting, by the AI module, the plurality of IoT devices from an IoT-events log database, wherein each device has one or more events indicating one or more operating state of each IoT device at a plurality of timestamps, and the one or more operating state includes usage history of the each IoT device with one or more operating capabilities;
determining, by the AI module, one or more confidence scores using correlation analysis between the one or more events of the plurality of IoT devices including the one or more operating capabilities for the each IoT device and the user input query; and
prioritizing, by the AI module, one or more IoT devices from the plurality of IoT devices as contextually relevant to the user input query based on the one or more determined confidence scores.

5. The method as claimed in claim 1,
wherein the dynamic UI is generated using a pre-trained machine learning module and configured within an interface device, and
wherein the pre-trained machine learning module has been trained with data including:
at least one user intent,
one or more determined confidence scores of the one or more IoT devices contextually relevant to the user input query,
the plurality of IoT devices and their location information,
history of interaction of a user with the plurality of IoT devices at a plurality of timestamps, and
one or more events indicating operating state with one or more operating capabilities and device usage history of the plurality of IoT devices at the plurality of timestamps.

6. The method as claimed in claim 1, wherein the user input query includes at least one of an audio input or a text input.

7. The method as claimed in claim 1, wherein the determining of the one or more control functions of the identified one or more IoT devices for achieving the localized ambience created by the plurality of IoT devices comprises:
identifying the at least one user intent based on user environment; and
analyzing one or more data in relation to operating the one or more IoT devices, including at least,
a plurality of capabilities and correlation of the one or more IoT devices,
user interaction with the one or more IoT devices, and
location of a user.

8. The method as claimed in claim 1,
wherein the plurality of IoT devices are arranged in a physical world,
wherein the dynamic UI is created in a metaverse world, and
wherein the generated dynamic UI enables the at least one user input query in the metaverse world to control the determined one or more control functions to achieve the localized ambience.

9. A method for generating a dynamic interface to control internet of things (IoT) devices arranged within a smart home, the method comprising:
receiving by an artificial intelligence (AI) module, information including a desired physical and mental state of a user;
identifying, by the AI module, one or more devices in the smart home and their associated operational parameters that are required to be adjusted to achieve the desired physical and mental state of the user; and
generating by the AI module an integrated user interface (UI) having the operational parameters of the identified one or more devices, wherein the operational parameters are user operable via the integrated UI in order to achieve a change in the physical and mental state of the user.

10. A device comprising:
memory storing instructions for an artificial intelligence (AI) module; and
at least one processor communicably coupled with the memory,
wherein the instructions, when executed by the at least one processor individually or collectively, cause the AI module to:
receive at least one user input query, wherein the at least one user input query includes at least one user intent for a localized ambience created by a plurality of internet of things (IoT) devices,
identify one or more IoT devices from the plurality of IoT devices as contextually relevant to the user input query,
determine one or more control functions of the identified one or more IoT devices for achieving the localized ambience created by the plurality of IoT devices, and
generate the dynamic user interface (UI) associated with the identified one or more IoT devices, wherein the generated dynamic UI enables the at least one user input query to control the determined one or more control functions to achieve the localized ambience.

11. The device as claimed in claim 10, wherein the instructions, when executed by the at least one processor individually or collectively, cause the AI module to:
retrieve the at least one user intent from the at least one user input query using a sentiment classification mechanism.

12. The device as claimed in claim 10, wherein the instructions, when executed by the at least one processor individually or collectively, cause the AI module to:
extract from an IoT-device-history database, a list of a plurality of IoT devices and their location information within an IoT environment.

13. The device as claimed in claim 10, wherein to identify the one or more IoT devices from the plurality of IoT devices as contextually relevant to the user input query, the instructions, when executed by the at least one processor individually or collectively, cause the AI module to:
extract the plurality of IoT devices from an IoT-events log database, wherein each device has one or more events indicating one or more operating state of each IoT device at a plurality of timestamps, and the one or more operating state includes usage history of the each IoT device with one or more operating capabilities,
determine one or more confidence scores using correlation analysis between the one or more events of the plurality of IoT devices including the one or more operating capabilities for the each IoT device and the user input query, and
prioritize one or more IoT devices from the plurality of IoT devices as contextually relevant to the user input query to the user input query based on the one or more determined confidence scores.

14. The device as claimed in claim 10,
wherein the dynamic UI is generated using a pre-trained machine learning module, and
wherein the pre-trained machine learning module has been trained with data including:
user intent,
one or more determined confidence score of the one or more IoT devices contextually relevant to the user input query,
the plurality of IoT devices and their location information,
history of interaction of a user with the plurality of IoT devices at a plurality of timestamps, and
one or more events indicating operating state with one or more operating capabilities and device usage history of the plurality of IoT devices at the plurality of timestamps.

15. The device as claimed in claim 10, wherein the user input query includes at least one of an audio input or a text input.

16. The device as claimed in claim 10, wherein to determine the one or more control functions of the identified one or more IoT devices for achieving the localized ambience created by the plurality of IoT devices, the instructions, when executed by the at least one processor individually or collectively, cause the AI module to:
identify the at least one user intent based on user environment, and
analyze one or more data in relation to operating the one or more IoT devices, including at least,
a plurality of capabilities and correlation of the one or more IoT devices,
user interaction with the one or more IoT devices, and
location of a user.

17. The device as claimed in claim 10,
wherein the plurality of IoT devices are arranged in a physical world,
wherein the dynamic UI is created in a metaverse world, and
wherein the generated dynamic UI enables the at least one user input query in the metaverse world to control the determined one or more control functions to achieve the localized ambience.

18. A device comprising:
memory storing instructions for an artificial intelligence (AI) module; and
at least one processor communicably coupled with the memory,
wherein the instructions, when executed by the at least one processor individually or collectively, cause the AI module to:
receive information including a desired physical and mental state of a user,
identify one or more devices in smart home and their associated operational parameters that are required to be adjusted to achieve the desired physical and mental state of the user, and
generate an integrated user interface (UI) having the operational parameters of the identified one or more devices, wherein the operational parameters are user operable via the integrated UI in order to achieve a change in the physical and mental state of the user.

19. One or more non-transitory computer-readable storage media storing instructions that, when executed by at least one processor of a device individually or collectively, cause the device to perform operations for an artificial intelligence (AI) module, the operations comprising:
receiving at least one user input query, wherein the at least one user input query includes at least one user intent for a localized ambience created by a plurality of internet of things (IoT) devices;
identifying one or more IoT devices from the plurality of IoT devices as contextually relevant to the user input query;
determining one or more control functions of the identified one or more IoT devices for achieving the localized ambience created by the plurality of IoT devices; and
generating the dynamic user interface (UI) associated with the identified one or more IoT devices, wherein the generated dynamic UI enables the at least one user input query to control the determined one or more control functions to achieve the localized ambience.

20. One or more non-transitory computer-readable storage media storing instructions that, when executed by at least one processor of a device individually or collectively, cause the device to perform operations for an artificial intelligence (AI) module, the operations comprising:
receiving information including a desired physical and mental state of a user;
identifying one or more devices in smart home and their associated operational parameters that are required to be adjusted to achieve the desired physical and mental state of the user; and
generating an integrated user interface (UI) having the operational parameters of the identified one or more devices, wherein the operational parameters are user operable via the integrated UI in order to achieve a change in the physical and mental state of the user.
